(19) United States
(12) Patent Application Publication
(10) Pub. No.: US 2006/0130264 A1
(43) Pub. Date: Jun. 22, 2006

(54) Limiter paint tray

(75) Inventors: Dennis M. Futo, Strongsville, OH (US); Scott A. Pyle, Vernon Hills, IL (US); Michael M. Sherman, Mooresville, NC (US); James C. Dale, Taylorsville, NC (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Zibra, LLC, Mooresville, NC (US)

(21) Appl. No.: 11/298,792

(22) Filed: Dec. 9, 2005

Related U.S. Application Data
(60) Provisional application No. 60/638,449, filed on Dec. 22, 2004.
(60) Provisional application No. 60/670,374, filed on Apr. 12, 2005.

(51) Int. Cl. B05C 21/00

(52) U.S. Cl. 15/257.06

(57) ABSTRACT

A paint tray system is configured to dispense paint onto a paint roller. The paint tray system includes a paint tray having a bottom section, an end wall and side walls forming a reservoir for holding paint. A paint limiter panel is received by the tray overlaying the reservoir in the paint tray, the limiter panel having at least one opening therein to allow paint to flow from the reservoir through the limiter panel. The paint tray system also includes at least one biasing member positioned within the reservoir configured to bias the limiter panel upwardly and away from the bottom section of the tray and thus the surface of the paint within the reservoir.

### REFERENCE TO RELATED APPLICATION

The present application claims priority under 35 U.S.C. §119(e) to U.S. Provisional Patent Application No. 60/638,449, filed Dec. 22, 2004 and entitled “Painting Tools” and U.S. Provisional Patent Application No. 60/670,374, filed on Apr. 12, 2005 and entitled “Painting Apparatus”.

### BACKGROUND OF THE INVENTION

1. Field of Invention

This invention relates to apparatus useful in painting applications, and more specifically to an improved paint tray system for applying paint to a paint roller.

2. Description of Related Art

There are a variety of painting tools, such as trays, buckets, paint rollers, and the like for use by painters to make the job of applying paint more efficient. For example, paint trays are used to provide a reservoir for paint in which to dip a paint roller. Typically, the paint trays have been flat, long, horizontal pans or even vertical buckets which have a paint reservoir and a ribbed angled deck wherein the saturated paint roller is rolled to remove excess paint. These types of paint trays all have a common deficiency—they allow the user to freely dip the paint roller without limitation into the reservoir. This creates over dipping and over saturation of the paint roller, which increases the mess caused by dripping and paint splatter. Additionally, it is often difficult to remove excess paint from the paint roller because the angled deck of the generic paint tray becomes saturated with paint. Thus, they are often messy and cumbersome to use.

Based on the foregoing, it would be desirable to provide an improved paint tray system that that provides greater utility and convenience to the user.

### SUMMARY OF INVENTIVE FEATURES

One aspect of the invention is directed to a paint tray system configured to dispense paint onto a paint roller. The paint tray system includes a paint tray having a bottom section, an end wall and side walls forming a reservoir for holding paint. A paint limiter panel is received by the tray overlaying the reservoir in the paint tray, the limiter panel having at least one opening therein to allow paint to flow from the reservoir through the limiter panel. The paint tray system also includes at least one biasing member positioned within the reservoir configured to bias the limiter panel upwardly and away from the bottom section of the tray and thus the surface of the paint within the reservoir.

Another aspect of the invention is a paint tray system configured to dispense paint onto a paint roller. The paint tray system includes a paint tray having a bottom section, an end wall and side walls forming a reservoir for holding paint. A paint limiter panel is received by the tray overlaying the reservoir in the paint tray, the limiter panel comprising a grate section having a plurality of openings that permit the flow of paint from the reservoir through the limiter panel. At least one biasing member is positioned within the reservoir and is configured to bias the limiter panel upwardly and away from the bottom section of the tray and thus the surface of the paint within the reservoir. When the limiter panel is pushed downwardly against the force of the biasing members, the limiter panel is positioned in the reservoir so that paint flows through the openings in the grate section to thereby coat the paint roller with paint. When the downward pressure is substantially removed from the limiter panel, the biasing members bias the limiter panel into an elevated position above the reservoir so that excess paint can be removed from the roller. The at least one biasing member is sized and is received within a recess in the limiter panel and/or in the bottom section of the tray so that the limiter panel contacts and bottoms out against the bottom section of the tray when the biasing member is substantially fully compressed.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a top perspective view of a paint tray system according to an embodiment of the invention;

FIG. 2 is a bottom perspective view of the paint tray system of FIG. 1;

FIG. 3 is an exploded view of the paint tray system of FIG. 1;

FIG. 4 is an alternate embodiment of a limiter panel of the paint tray system of FIG. 1; and

FIG. 5 is another embodiment of a limiter panel of the paint tray system of FIG. 1.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

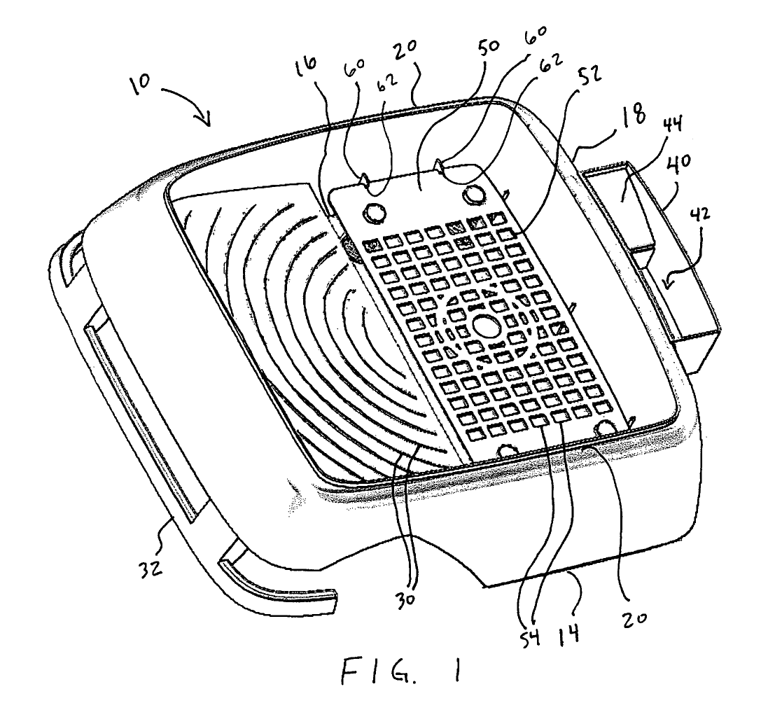

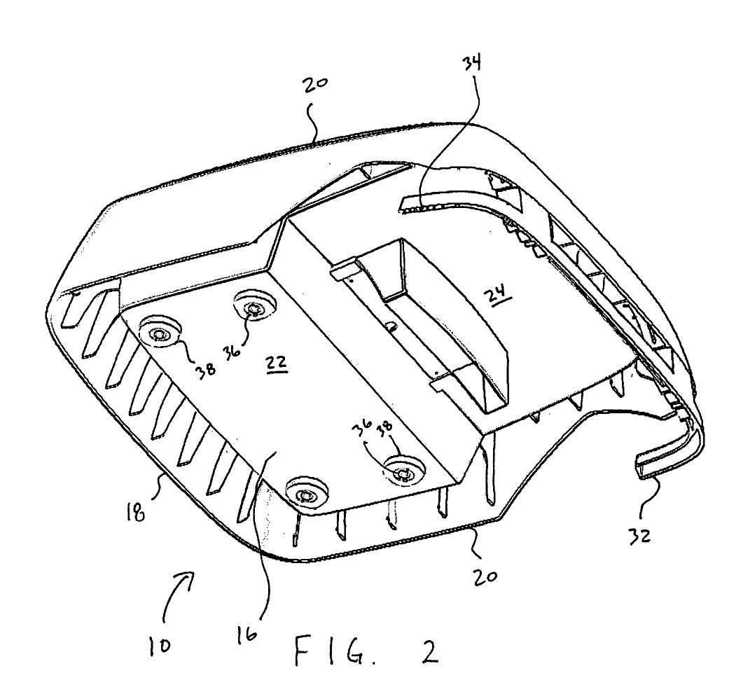

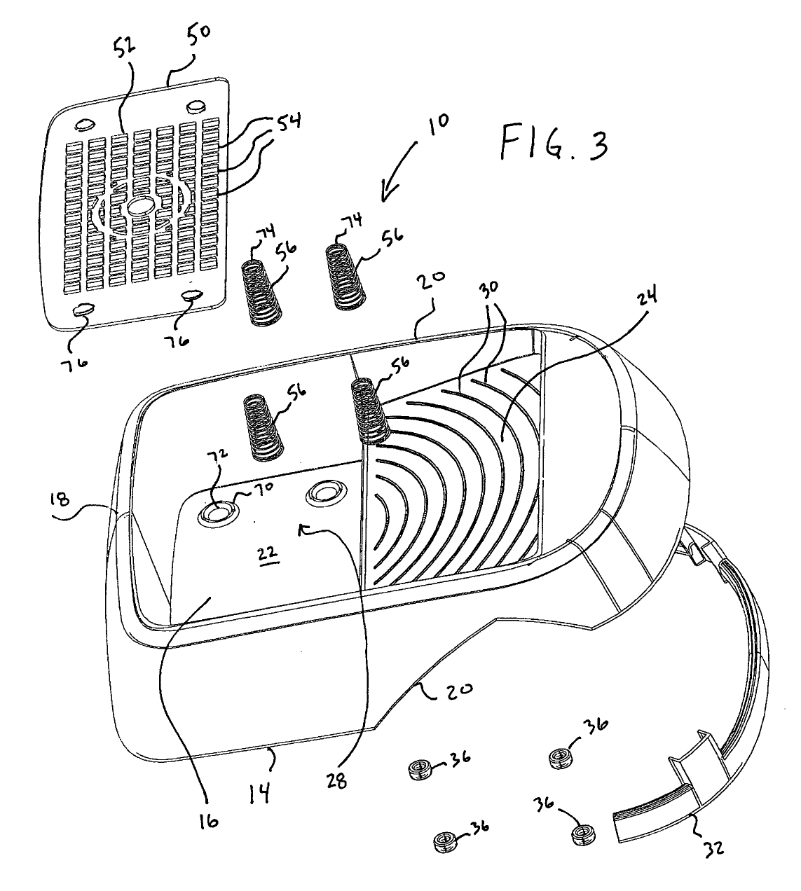

Referring now to the Figures, FIGS. 1 and 2 illustrate a paint tray system 10 for dispensing paint and paint-like products onto a paint roller. The tray system 10 is particularly described for use with paint, however, it is clear that it can be equally useful with other materials that may be applied with a roller, such as some adhesives, cements and the like. The paint tray system 10 comprises a paint tray 14 configured to receive a paint roller (not shown) so that the paint roller may be dipped into the tray 14 to dispense paint onto the roller. The paint tray 14 has a bottom section or portion 16 having at one end an end wall 18. Extending from the bottom section 16 and the end wall 18 are two side walls 20. As best seen in the exploded view of FIG. 3, the bottom section 16 of the paint tray 14 is divided near the middle of its length into a flat surface 22 and an inclined surface 24 extending up from the flat surface 22 which slopes upward to a position adjacent the upper edge of the side walls 20. The end wall 18 and the side walls 20 form in conjunction with the flat surface 22 of the bottom section 16 a reservoir 28 in which paint can be stored for use. Located on the inclined surface 24 of the bottom section 16 of the tray 10 are a series of ribs 30 which are used to more evenly spread the paint over the surface of the paint roller and to strengthen the bottom section 16.

A sled leg 32 is provided for the tray 14 adjacent the inclined surface 24 to keep the tray 14 substantially level when resting on a flat surface. The sled leg 32 also acts as a ladder step bracket when the tray system 10 is supported on a ladder. The sled leg 14 may be provided with a rubberized tread 34 to prevent slipping of the tray system 10. Additionally, rubberized pads 36 may be received on feet 38 molded into the bottom section 16 of the tray 14. In one embodiment, a trough 40 is attached to or molded in the end wall 18 to provide a brush well or receptacle 42 on the paint tray system 10. The brush well 42 has an inclined ledge 44 that forms a handle nest within the well 42. The brush well 42 and handle nest is configured to receive paint brushes when they are not in use. Desirably, the brush well 42 is positioned on the side of the tray 10 opposite the inclined surface 24 of the bottom section 16 so that brushes stored therein do not interfere with the paint roller as it is being charged with paint from the paint reservoir 28.

According to the invention, the paint tray system 10 has a paint limiter panel 50 that is received by the tray 14 overlaying the reservoir 28. The paint limiter panel 50 has a grate section 52 with numerous openings 54 that permit the flow of paint through the paint limiter panel 50. As best seen in the exploded view of FIG. 3, biasing members, such as springs 56, bias the limiter panel 50 upwardly and away from the bottom section 16 of the tray 14 and thus the surface of the paint within the reservoir 28. A paint roller (not shown) is used to push the limiter panel 50 downwardly while being rolled across the top of the grate section 52 to submerge the limiter panel 50 into the paint a short distance. With the limiter panel 50 submerged in the paint, paint flows through the openings 54 in the grate section 52 to thereby coat the paint roller with paint. When the downward pressure from the paint roller is substantially removed from the limiter panel 50, the springs 56 bias the limiter panel 50 into an elevated position above the paint level in the reservoir 28. In the elevated position, excess paint can be removed from the roller by passing the roller over the grate section 52 and allowed to drip back into the paint reservoir 28. Rolling the paint roller over the inclined surface 24 and ribs 30 then evenly spreads the paint over the surface of the roller. The limiter panel 50 thus prevents the roller and the inclined surface 24 from being deluged with paint after dipping the roller into the reservoir 28.

In one embodiment, the tray 14 desirably has guides 60 molded into the sidewalls 20 and/or end wall 18 that are received into grooves 62 in the limiter panel 50 to guide the limiter panel when under compression by the paint roller. Alternately, the guides (not shown) may be on the limiter panel 50 and be received into grooves (not shown) in the tray 14.

Desirably, the springs 56 are sized such that when the springs 56 are fully compressed, they allow the limiter panel 50 to bottom out against the bottom section 16 of the tray 14 so that substantially all of the paint contained in the reservoir 28 may be used by the paint roller. In one embodiment as best seen in FIG. 3, the molded feet 38 provide recesses 70 with internal bosses 72 to register and trap the springs 56 and prevent the springs 56 from leaning or migrating under pressure during use. Additionally, top portions 74 of the springs 56 are received in recesses 76 in the limiter panel 50. The springs 56 may compress within the recesses 70 in the molded feet 38 and the recesses 76 in the limiter panel 50 so that the grate section 52 of the limiter panel 50 contacts and bottoms out against the bottom section 16 of the tray 14 when the springs 56 are substantially fully compressed.

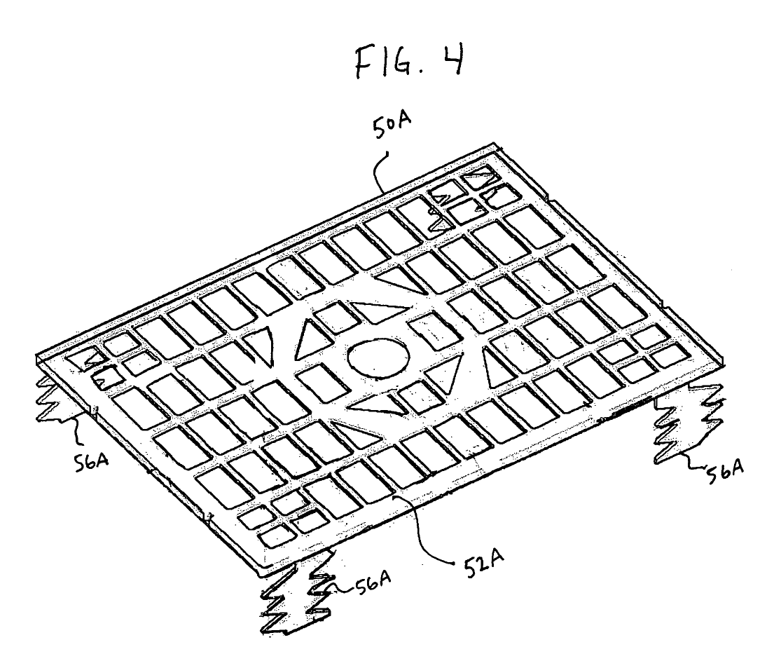

FIG. 4 illustrates another embodiment of a limiter panel 50A. Limiter panel 50A contains biasing members or springs 56A molded into the limiter panel 50A. The biasing members 56A may be in the form of coil springs, leaf springs, or other biasing members selected using sound engineering judgment. The biasing members 56A may be received in recesses 70 (FIG. 3) in the tray 14 as set forth above.

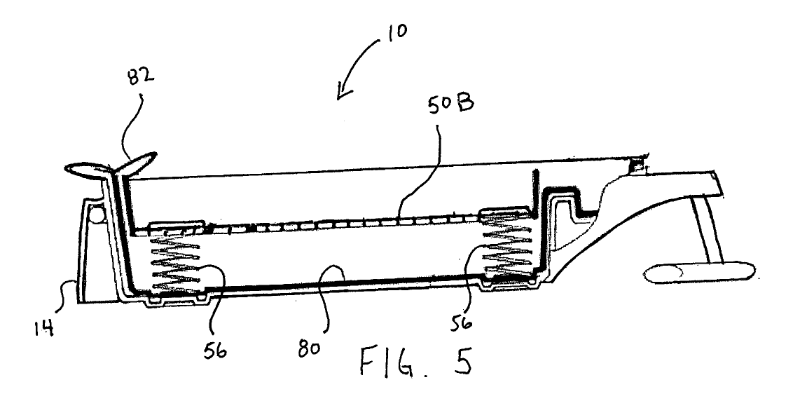

Alternately, in another embodiment illustrated in FIG. 5, the tray 14 may receive a disposable liner 80. The disposable liner 80 may be formed such that a limiter panel 50B is formed as a single polypropylene part of the liner 80 featuring a living hinge 82. The elongated living hinge 82 allows the limiter panel 50B to travel up and down inside the reservoir 28 to reach the paint level with or without springs 56.

In one embodiment, the paint tray system 10 includes an optional snap-on lid (not shown) that covers the reservoir 28 of the paint tray 14 to cover the paint during breaks in painting and reduce spillage during transport of the paint tray system 10. The lid desirably has one or more recess for storing the paint roller, paint brushes, or other painting accessories.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A paint tray system configured to dispense paint onto a paint roller, the paint tray system comprising:
a paint tray having a bottom section, an end wall and side walls forming a reservoir for holding paint;
a paint limiter panel received by the tray overlaying the reservoir in the paint tray, said limiter panel having at least one opening therein to allow paint to flow from the reservoir through the limiter panel; and
at least one biasing member positioned within the reservoir configured to bias the limiter panel upwardly and away from the bottom section of the tray and thus the surface of the paint within the reservoir.

2. The paint tray system of claim 1 wherein the bottom section of the paint tray comprises a flat surface and an inclined surface extending up from the flat surface which slopes upward to a position adjacent the upper edge of the side walls.

3. The paint tray system of claim 1 further comprising a trough in the end wall to provide a brush well, wherein the brush well has an inclined ledge that forms a handle nest within the well, wherein the brush well is positioned on the side of the tray opposite the inclined surface of the bottom section so that brushes stored therein do not interfere with the paint roller as it is being charged with paint from the paint reservoir.

4. The paint tray system of claim 1 wherein the paint limiter panel has a grate section having a plurality of openings that permit the flow of paint through the paint limiter panel.

5. The paint tray system of claim 1 wherein the limiter panel is pushed downwardly against the force of the biasing members to position the limiter panel in the reservoir so that paint can flow through the openings in the grate section to thereby coat the paint roller with paint, and when the downward pressure is substantially removed from the limiter panel, the biasing members bias the limiter panel into an elevated position above the reservoir so that excess paint can be removed from the roller

6. The paint tray system of claim 1 wherein the tray has guides molded into the sidewalls and/or end wall that are received into grooves in the limiter panel to guide the limiter panel.

7. The paint tray system of claim 1 wherein the springs are sized such that when the springs are fully compressed, they allow the limiter panel to bottom out against the bottom section of the tray.

8. The paint tray system of claim 7 wherein the bottom section of the tray has recesses with internal bosses to register and trap the springs so that the limiter panel contacts and bottoms out against the bottom section of the tray when the springs are substantially fully compressed.

9. The paint tray system of claim 7 wherein top portions of the springs are received in recesses in the limiter panel so that the limiter panel contacts and bottoms out against the bottom section of the tray when the springs are substantially fully compressed.

10. The paint tray system of claim 1 wherein the limiter panel contains biasing members molded into the limiter panel.

11. The paint tray system of claim 1 wherein the biasing members are coil springs.

12. The paint tray system of claim 1 wherein the biasing members are leaf springs.

13. The paint tray system of claim 1 wherein the tray receives a disposable liner and the disposable liner comprises a limiter panel formed as a single part of the liner with a living hinge.

14. A paint tray system configured to dispense paint onto a paint roller, the paint tray system comprising:
a paint tray having a bottom section, an end wall and side walls forming a reservoir for holding paint;
a paint limiter panel received by the tray overlaying the reservoir in the paint tray, said limiter panel comprising a grate section having a plurality of openings that permit the flow of paint from the reservoir through the limiter panel; and
at least one biasing member positioned within the reservoir configured to bias the limiter panel upwardly and away from the bottom section of the tray and thus the surface of the paint within the reservoir, wherein when the limiter panel is pushed downwardly against the force of the biasing members, the limiter panel is positioned in the reservoir so that paint flows through the openings in the grate section to thereby coat the paint roller with paint, and when the downward pressure is substantially removed from the limiter panel, the biasing members bias the limiter panel into an elevated position above the reservoir so that excess paint can be removed from the roller, and wherein the at least one biasing member is received within a recess in the limiter panel and/or in the bottom section of the tray so that the limiter panel contacts and bottoms out against the bottom section of the tray when the at least one biasing member is substantially fully compressed.

15. The paint tray system of claim 14 further comprising a trough in the end wall to provide a brush well, wherein the brush well has an inclined ledge that forms a handle nest within the well, wherein the brush well is positioned on the side of the tray opposite the inclined surface of the bottom section so that brushes stored therein do not interfere with the paint roller as it is being charged with paint from the paint reservoir.

16. The paint tray system of claim 14 wherein the tray has guides molded into the sidewalls and/or end wall that are received into grooves in the limiter panel to guide the limiter panel.

17. The paint tray system of claim 14 wherein the limiter panel contains biasing members molded into the limiter panel.

18. The paint tray system of claim 14 wherein the biasing members are coil springs.

19. The paint tray system of claim 14 wherein the biasing members are leaf springs.
